(19) United States
(12) Patent Application Publication
(10) Pub. No.: US 2015/0066621 A1
(43) Pub. Date: Mar. 5, 2015

(54) METHOD AND APPARATUS FOR PROVIDING ADVERTISEMENTS TO CUSTOMERS

(71) Applicant: Motorola Solutions, Inc, Schaumburg, IL (US)

(72) Inventors: VIJAYADITYA KAKARLAPUDI, KAKINADA (IN); SAURAV KUMAR, BANGALORE (IN)

(73) Assignee: Motorola Solutions, Inc, Schaumburg, IL (US)

(21) Appl. No.: 14/010,692

(22) Filed: Aug. 27, 2013

(51) Int. Cl. G06Q 30/02

(52) U.S. Cl. CPC G06Q 30/0255
USPC 705/14.25

(57) ABSTRACT

A method and apparatus for providing targeted advertisements are provided herein. During operation a system will determine a shopper's intent based on the shopper's attire (i.e., what the shopper is wearing and/or carrying). Specific advertisements will be sent to the shopper based on the shopper's attire. Because advertisements will be provided to shoppers based on the shopper's attire, shoppers will be more likely to receive an advertisement better tailored to their current needs.

### FIELD OF THE INVENTION

The present invention generally relates to advertisements, and more particularly to providing targeted advertisements to customers.

### BACKGROUND OF THE INVENTION

Many stores, track customer purchases in order to keep a database of the buying habits of their customers. This is usually accomplished by offering “rewards cards” to their customers to increase customer loyalty. These reward cards (i.e. loyalty cards, club cards, preferred customer cards, etc.) provide the customer with discounts or points for a future purchases in return for personal information. Retailers use the personal information to track purchasing habits of their customers. A backend database is used for tracking customer purchases (customer preferences) along with techniques to determine more efficient marketing campaigns and advertising opportunities.

Prior-art systems have been designed to provide targeted advertisements to customers based on their shopping habits. For example, US Pub. No. 2002/0174025, entitled METHOD AND SYSTEM FOR PROVIDING TARGETED ADVERTISING AND PERSONALIZED CUSTOMER SERVICES, (incorporated by reference herein) provides for a system that tailors specific advertisements to customers that are currently shopping.

With the many hundreds of items a customer may purchase on a regular basis, it is often difficult to determine products the customer is looking for when they enter a store. For example, a shopper may enter the store with the intent of doing their weekly grocery shopping, or the shopper may enter the store with the intent of picking up an energy drink before heading to the gym. As is evident, it would be beneficial to target different advertisements to the shopper in the above two scenarios. Any technique that aides in determining a shopper's intent (intended products to purchase) would be beneficial to a system providing targeted advertisements to the shopper. Therefore a need exists for a method and apparatus for providing targeted advertisements to shoppers that targets advertisements to the shopper based on their intent.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general operational environment, according to one embodiment of the present invention;

FIG. 2 is a block diagram of a system for providing targeted advertising and personalized customer services using a wireless communication device according to a second embodiment of the present invention.

FIG. 3 is a flow chart showing operation of the systems of FIG. 1 and FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for providing targeted advertisements are provided herein. During operation a system will determine a shopper's intent based on the shopper's attire (i.e., what the shopper is wearing and/or carrying). Specific advertisements will be sent to the shopper based on the shopper's attire. Because advertisements will be provided to shoppers based on the shopper's attire, shoppers will be more likely to receive an advertisement better tailored to their current needs.

It should be noted that a shopper's attire is not necessarily limited to what the clothing worn by the shopper. It is intended that the term “attire” means anything worn or carried by the shopper. For example, items like sunglasses, purses, bags, jewelry, or any other item carried by a shopper are considered herein to be part of a shopper's attire. It should also be noted that the terms customer, individual, and shopper are meant to be interchangeable. These terms are meant to describe a person who is shopping for particular items.

With the above in mind, if a shopper enters a store carrying multiple shopping bags, it can be assumed that many items will be purchased and that the shopper is shopping for their weekly grocery supplies. On the other hand, if the shopper enters the store carrying no bags and dressed in workout clothes, it can be assumed that the shopper is in the store to pick up a few needed items related to a workout. In each case, advertisements may be targeted to the shopper accordingly. For example, in the first scenario, advertisements may be presented to the shopper that relate to sales on a customer's preferred grocery items (past purchases of grocery supplies). In the second scenario, advertisements may be presented to the shopper that relate to sports fitness products. Thus, in the first scenario the shopper may be provided with the weekly sales on vegetables and meats, where in the second scenario the shopper may be provided with sale information on sports energy drinks or nutritional supplements.

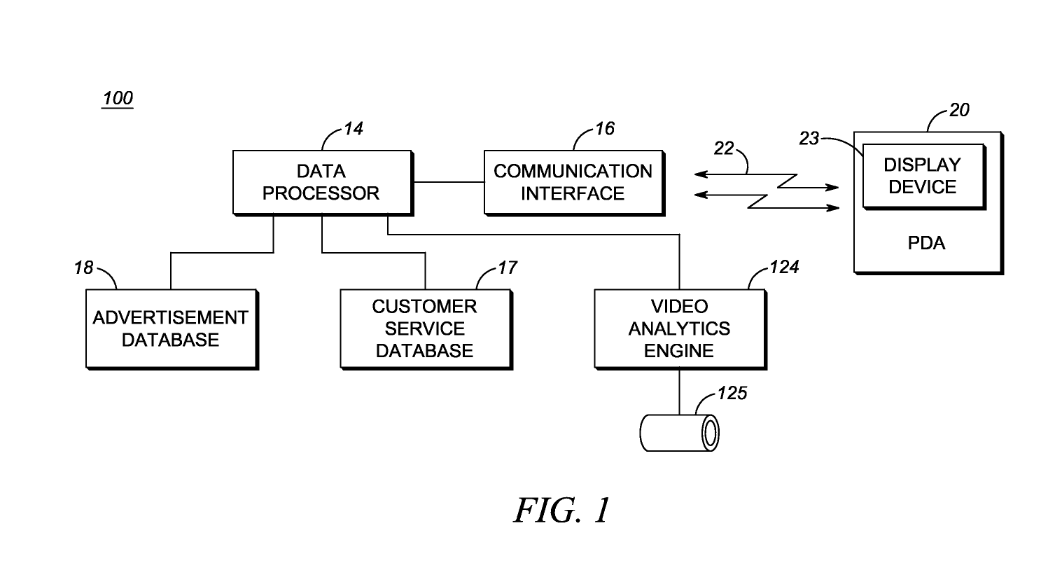

FIG. 1 is a block diagram of a system 100 for providing targeted advertising. The system is preferably similar to the system described in the '025 publication discussed above. The system 100 can be implemented in or for a store, shopping mall, or other shopping area or environment. As shown in FIG. 1, the system 100 includes a data processor 14, multiple communication interfaces 16 (only one shown), a customer service database 17, an advertisement database 18, a video/image analytics engine 124, a camera 125, and at least one customer interface 20. Customer interface 20 (including display device 23) may comprise a personal-digital assistant (PDA) 20 carried by a user such as a customer, or may simply comprise a customer's smartphone running an appropriate application, and serving as a customer interface to system 100. In alternate embodiments of the present invention interface 20 may comprise devices using other means of communications such as, but not limited to voice-mail, email, text, messaging, etc. Regardless of the form customer interface 20 takes, interface 20 will comprise a graphical user interface that provides targeted advertisements to the user of device 20, and will be described below in system 100 as a user's smartphone.

The smartphone 20 comprises a conventional smartphone capable of short-range wireless communication 22 with the communication interface 16 according to known communication techniques such as infrared communication or “Bluetooth” techniques. Although not shown in FIG. 1, device 20 also contains a communication interface.

To provide short-range wireless communication 22 between the smartphone 20 and the communication interface 16, e.g., using Bluetooth techniques, each of the smartphone 20 and the communication interface 16 includes therein a Bluetooth radio unit known in the art.

When the smartphone 20 carried by the customer is present within a predetermined communication range of the communication interface 16 and the smartphone 20 is in a state where communication is enabled, the communication interface 16 initiates communication with the smartphone 20 through any short-range wireless communication such as the Bluetooth radio units according to Bluetooth techniques, and is able to access automatically certain information or files stored in the smartphone 20, such as shopping list files, to-do list information, purchase history, product preferences, etc. One or any combination of this information is referred to herein as “preference information” identifying products, brands, stores, language, color, currency, size, or any other item preferred by the customer. This information is added to customer service database 17, which may added/appended to past customer-preference information.

The communication interface 16 transmits the preference information collected from the customer's smartphone 20 to the data processor 14. The data processor 14 then processes the preference information and utilizes this information and previously collected preference information (such as purchased items) as variables used to select appropriate advertisements for the customer.

To select appropriate advertisements that would be likely to interest the customer, i.e., to provide targeted advertising to the customer, the data processor 14 correlates preference information with a list of advertisements that are available in advertisement database 18 and is configured to select appropriate advertisement(s) based on the correlation results according to certain criteria. The advertisements can be stored in the advertisement database 18 or any other location accessible by the data processor 14. The selected advertisements are communicated to the customer's smartphone 20 via the short-range wireless communication 22, and displayed on a display device 23 such as a screen on the smartphone 20. Different targeted advertisements may be displayed on the display device 23 as the customer roams around the store or appropriate shopping area. In one embodiment of the present invention an advertisement may comprise sale information on items that the user of device 20 may be interested in purchasing.

Accordingly, the present invention advantageously provides targeted advertising and advertisements using the smartphone or other communication device registered by the customer based on the customer's preference information.

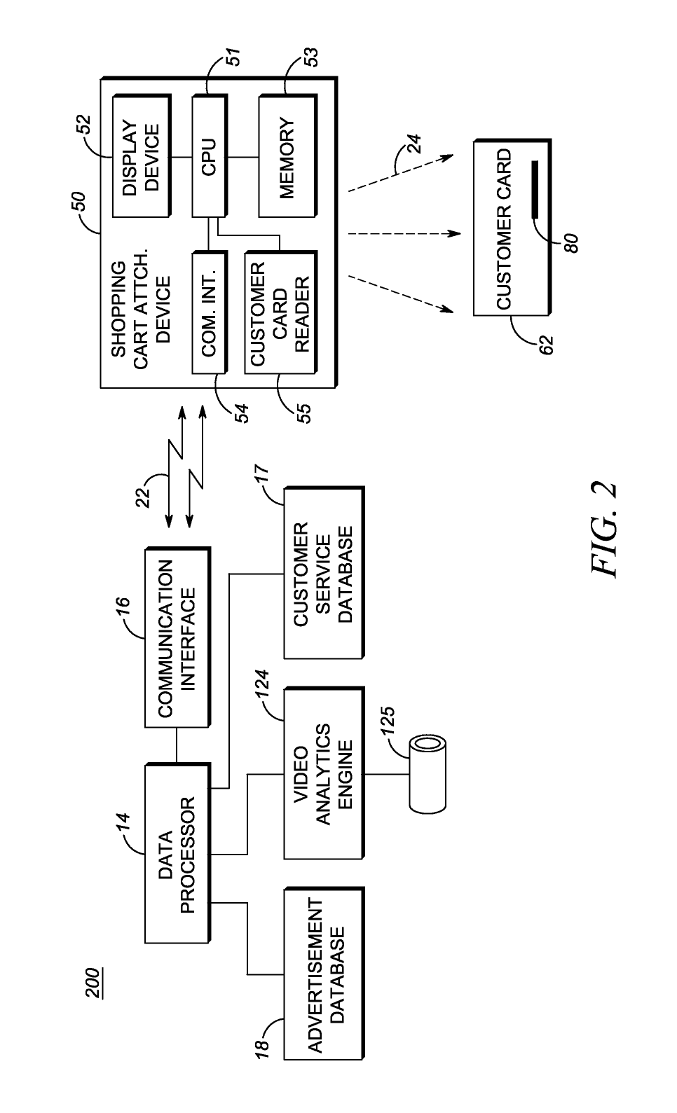

FIG. 2 is a block diagram of a system 200 for providing targeted advertising and personalized customer services using a wireless communication device according to a second embodiment of the present invention. As shown in FIG. 2, the system 200 includes a data processor 14, a communication interface 16, a customer service database 17, an advertisement database 18, and a shopping cart attachment device 50, all operatively coupled. In this embodiment, in lieu of the customer's smartphone 20 (FIG. 1), the communication interface 16 communicates with the shopping cart attachment device 50.

The shopping cart attachment device 50 is preferably installed on a conventional shopping cart that customers use during their shopping. The shopping cart attachment device 50 includes a CPU (Central Processing Unit) 51, a display device 52, memory 53, a communication interface 54, and a customer card reader 55, all operatively coupled. The communication interface 54 is configured to perform short-range wireless communication 22 with the communication interface 16 using known communication techniques such as infrared or Bluetooth communication techniques, a combination of Bluetooth and wireless or wired LAN, etc.

The customer card reader 55 is a conventional card reader for reading a customer card 62 such as a membership card, a credit card, a debit card, a customer ID card. The customer card 62 includes a storage unit 80 for storing the customer's personal information, preference information, etc. The storage unit 80 can be in the form of an optical medium, a magnetic stripe, a chip, a RFID (Radio Frequency Identification) tag, a hologram, etc. Depending on the type of the storage unit 80, the type of the customer card reader 55 will vary. For example, if the storage unit 80 of the customer card 62 is a RFID tag, the customer card reader 55 will be a RFID tag reader for scanning radio signals from the RFID tag wirelessly. If the storage unit 80 of the customer card 62 is a semiconductor chip, then the customer card reader 55 is a smart card reader for reading the chip when the customer card 62 is inserted into the card reader 55. All these storage units and card readers are well known in the art. If the storage unit 80 is a RFID tag, the customer's preference information pre-stored in the RFID tag of the customer card 62 can be updated on a regular basis by rewriting wirelessly the information stored in the RFID tag according to known RFID tag techniques as the customer's preference changes. In addition, the storage unit 80 can be configured to store therein the demographic information about the owner of the card 62. The demographic information can supplement the preference information to provide more targeted advertising and more personalized customer services.

In the systems of both FIG. 1 and FIG. 2, camera 125 and video analytics engine 124 may be utilized to better tailor advertisements sent to the shopper. In both scenarios where the customer preferences are, and are not available to the system, an attempt at determining the shopper's intent may be made by analyzing what the shopper is wearing and/or carrying, and providing advertisements based on what the shopper is wearing and/or carrying. In this situation, data processor 14 (which may comprise a microprocessor) will:
associate a particular shopper with a particular device 20;
determine customer preferences (if available), which may include past items purchased by the user of device 20, 50, and items existing on the customer's shopping list;
determine the shopper's attire;
determine appropriate advertisements based on the shopper's attire and the customer preferences (if available); and
transmit the appropriate advertisements to the user.

The above-described steps will result in an advertisement being provided to a device based on what the shopper's attire. This will greatly aide in determining a shopper's intent when customer preferences are known and unknown.

Associating a Particular Shopper with a Particular Device 20, 50

During the use of system 100 or 200, there may be many shoppers roaming a store. There must be a technique to associate particular shoppers that are detected by engine 124 with their associated devices 20 or 50. In other words, when devices 20 or 50 are detected, a need arises to determine “who” is in possession of the detected devices 20, 50. Thus, when a customer enters a store, video analytics engine 124 must be able to associate a particular shopper with a particular device 20 or 50.

In both systems described above, many communication interfaces 16 may be distributed throughout an area. As discussed above, communications to devices 20 and 50 through interfaces 16 are preferably done via short-range communications 22 such as Bluetooth. Thus, when a customer enters a store, they will preferably pass in close proximity to at least one communication interface 16 to register their device 20 or 50. When this occurs, camera 125 will detect the user and video analytics engine 124 will associate the detected user with the particular device being registered. This association will be maintained until the user exits the premises.

In an alternate embodiment of the present invention, facial recognition may be used by engine 124 to identify an associated device. For example, during a registration process, a user may have registered their face with a particular device 20. When video analytics engine detects the presence of a particular face, data processor 14 can associate the face with a particular device 20.

### Determining Customer Preferences:

During operation of system 100 and 200, a user may scan their customer loyalty card. When scanned, data processor 14 can access customer service database 17 to retrieve “customer preference information”. This information may comprise items for sale, such as past items purchased by the customer. Where facial recognition is used, customer preference information may be associated with a particular identified individual.

Customer preferences may also include items currently on the customer's shopping list. For example, the user of the system shown in FIG. 1 and FIG. 2 may provide the system with a shopping list that may analyzed by processor 14 and added to the customer's preferred items.

### Determining the Shopper's Attire:

The systems of FIG. 1 and FIG. 2 both employ video analytics engine 124 and camera 125 will employ standard video analytics software/hardware to determine the shopper's attire. For example, it might be determined that the user of device 20 or 50 is:
carrying a single shopping bag;
wearing formal jewelry;
wearing no jewelry;
carrying multiple shopping bags;
carrying no shopping bag;
wearing sports attire;
wearing formal attire;
wearing casual attire;
etc.

### Determining Appropriate Advertisements Based on What the Shopper's Attire:

There are two possible scenarios that exist when attempting to identify a customer's intent:

1. The customer's preferences are known; and
2. The customer's preferences are unknown.

When a customer's preferences are known, advertisements are sent to the customer that are based the customer's preferences and their attire. When a customer's preferences are unknown, the systems of FIG. 1 and FIG. 2 will provide advertisements to the customer based solely on their attire (i.e., what they are wearing and/or carrying).

Determining the Customer's Intent when the Customer's Preferences are Known:

During the operation of the systems of FIG. 1 and FIG. 2, processor 14 will identify the customer and obtain information on what the customer is wearing/carrying. Database 17 contains information such as Customer Jones purchased a sports drink when wearing workout clothes, Customer Jones purchased weekly groceries when carrying multiple bags into the store, Customer Jones purchased a cup of coffee when dressed in work attire (formal clothes), . . . , etc. Thus, past preference information will be associated with clothing or items carried at the time of purchase. Therefore, when Customer Jones enters the store, processor 14 will be provided the attire, this information can be used to determine past purchases for Customer Jones when dressed in that attire. So, for example, if Customer Jones enters the store wearing formal clothing, data processor 14 can access video analytics engine to determine the attire, then access database 17 to determine items purchased when wearing formal clothing.

Determining the Customer's Intent when the Customer's Preferences are Unidentified:

As discussed above, there may be instances when a customer's preferences cannot be obtained. When this occurs, the customers intent will then be based solely on what the customer's attire (i.e., what they are wearing and/or carrying). Advertisements are presented to the shopper based on what the shopper is wearing and/or carrying.

In addition to customer preference data for identified customers, database 17 may contain those items purchased by unidentified customers along with their attire. This information is then used to determine appropriate advertisements to present to customer's whose preferences remain unknown. For example, database 17 may contain information as shown in Table 1.

TABLE 1

| Customer Name | Preferred Items | Attire |
|---|---|---|
| Jones | Candy Bar | Street clothes, |
| | | no bag carried |
| Jones | Sports Drink | Workout clothes, |
| | | no bag carried |
| Kim | Coffee | Formal Attire, |
| | | no bag carried |
| Customer having | Hamburger, Bread, | Street Clothes, |
| Unknown preferences | Fresh Vegetables, Acme | multiple |
| (unidentified customer) | Cleaner, . . . , Batteries | bags carried |
| . . . | | |

As mentioned above, the database 17 illustrated in Table 1 also contains entries for customer's who have unknown preferences. These customer's may comprise customers who are unable to be identified, or first-time shoppers. Thus, when a customer's preferences are not able to be determined, database 17 will provide information on past items purchased by such customers along with their attire. This information may be used when a customer's identity remains unknown. Thus, when a customer is unidentified, the systems of FIG. 1 and FIG. 2 may “identify” them as an “unidentified customer” so that past preference information may be used.

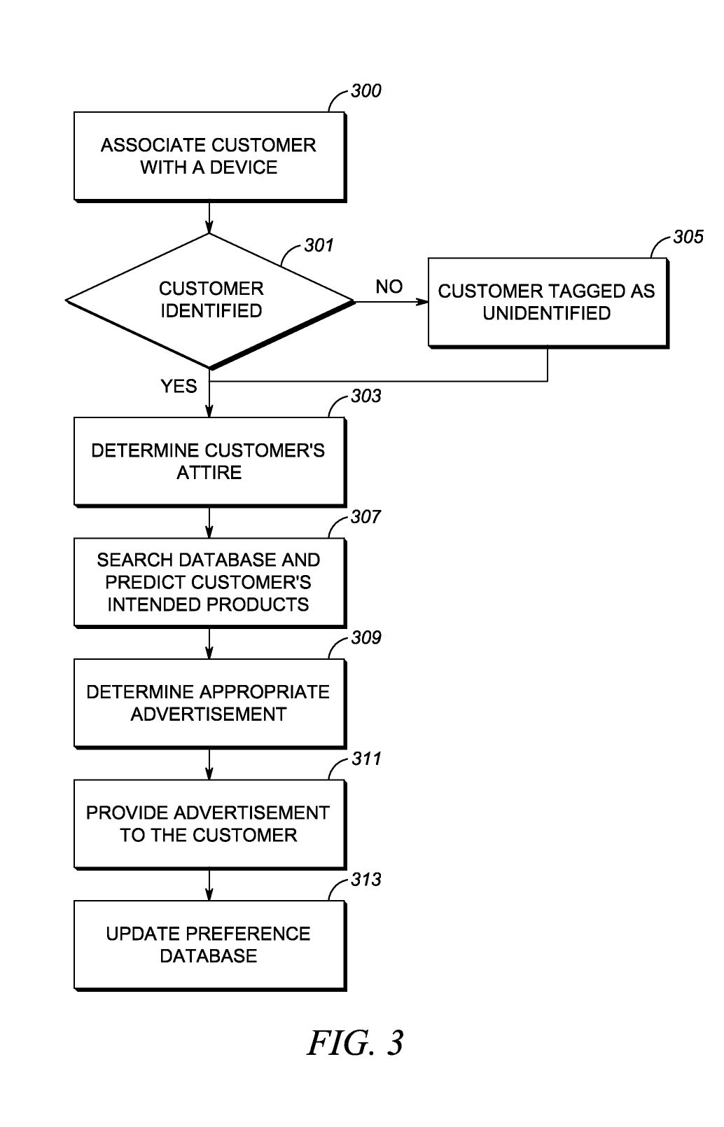

FIG. 3 is a flow chart showing operation of the system of FIG. 1 and FIG. 2. The logic flow begins at step 300 where a customer is associated with a device by processor 14. As discussed above, this step is used to determine what device is currently being used by the customer. At step 301 where processor 14 attempts to identify the customer using the device. If the customer is identified, then the logic flow continues to step 303. If, however, the customer remains unidentified, then the logic flow continues to step 305 where the customer is tagged as an “unidentified” customer. At step 303, processor 14 accesses analytics engine 124 to determine the customer's attire. As discussed above, the customer's attire may comprise what the customer is wearing, what the customer is carrying, or a combination of both. This information is then used by processor 14 at step 307 to search database 17 and predict the customer's intended products. More particularly, database 17 contains past purchases by the identified customer (customer preferences) along with the customer's attire when those items were purchased. Database 17 also contains past purchases by unidentified customers (or customers whose preferences are unknown) along with the unidentified customer's attire when those items were purchased. Once the customer's attire is determined (step 303), this information is accessed by processor 14 to determine past purchases when dressed in the identified attire (step 307). At step 309, processor 14 accesses advertisement database 18 to determine an appropriate advertisement based on the customer preferences when dressed in the particular attire, and at step 311 the advertisement is wirelessly provided to the customer (e.g., to their smartphone) via transmission circuitry, wherein the advertisement is based on the customer's attire, and optionally, the customer's preferences. When basing the advertisement on the customer's preferences, the advertisement may comprise an advertisement regarding a product identified within the customer's preferences.

The logic flow may continue to step 313 where the customer preference database is updated. with items ultimately purchased by the customer. When adding these items to database 17, processor 14 will also note the attire for the customer so that this information may be added as well.

Those skilled in the art will further recognize that references to specific implementation embodiments such as “circuitry” and “processors” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for providing an advertisement to a customer, the method comprising the steps of:
associating a customer with a device;
determining the customer's attire;
providing an advertisement to the customer based on their attire.

2. The method of claim 1 wherein the step of associating the customer with the device comprises the step of determining the device used by the customer.

3. The method of claim 1 wherein the step of determining the customer's attire comprises the step of determining what the customer is wearing and carrying.

4. The method of claim 1 wherein the step of determining the customer's attire comprises the step of determining what the customer is wearing.

5. The method of claim 1 wherein the step of determining the customer's attire comprises the step of determining what the customer is carrying.

6. The method of claim 1 further comprising the steps of:
identifying the customer;
determining the customer's preferences; and
wherein the step of providing the advertisement is additionally based on the customer's preferences.

7. The method of claim 6 wherein the advertisement comprises and advertisement of a product identified within the customer's preferences.

8. The method of claim 1 wherein the step of providing the advertisement to the customer comprises the step of wirelessly transmitting the advertisement to a customer's smartphone.

9. A method for providing an advertisement to a customer, the method comprising the steps of:
determining a device used by the customer;
determining what the customer is wearing and/or carrying;
wirelessly providing an advertisement to the customer's smartphone based on what the customer is wearing and/or carrying.

10. The method of claim 9 further comprising the steps of:
identifying the customer;
determining the customer's preferences; and
wherein the advertisement is additionally based on the customer's preferences.

11. An apparatus comprising:
a processor associating a customer with a device;
video/image analytic circuitry determining the customer's attire; and
transmission circuitry providing an advertisement to the customer based on their attire.

12. The apparatus of claim 11 wherein the customer's attire comprises what the customer is wearing and carrying.

13. The apparatus of claim 11 wherein the customer's attire comprises what the customer is wearing.

14. The apparatus of claim 11 wherein the customer's attire comprises what the customer is carrying.

15. The apparatus of claim 11 further comprising:
a customer preference database; and
wherein the advertisement is additionally based on the customer's preferences.
